(19) United States
(12) Patent Application Publication
(10) Pub. No.: US 2008/0311792 A1
(43) Pub. Date: Dec. 18, 2008

(54) USB CONNECTOR DEVICE, CONNECTOR MODULE AND METHOD FOR FABRICATING USB CONNECTOR DEVICE

(75) Inventors: Wen-Hsiung Hung, Taipei County (TW); Lik-Wei Chu, Taipei City (TW); Chia-Ming Hu, Taipei County (TW); Wei-Hsiang Wang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Transcend Information, Inc., Taipei (TW)

(21) Appl. No.: 11/867,697

(22) Filed: Oct. 5, 2007

(30) Foreign Application Priority Data
Jun. 15, 2007 (TW) 96121872

(51) Int. Cl. H01R 13/648; H01R 24/00; H01R 43/20

(52) U.S. Cl. 439/607; 29/876; 439/660

(57) ABSTRACT

A universal serial bus (USB) connector device includes a substrate and a terminal element. The substrate includes a main portion and a connector portion. The main portion includes a control circuit, and the connector portion includes a plurality of signal terminals to be coupled to the control circuit of the main portion. In addition, the terminal element may be jointed to the connector portion of the substrate, and includes a conductive wire layer to be coupled to the signal terminals of the substrate.

### CROSS-REFERENCE TO RELATED APPLICATION

This application claims the priority benefit of Taiwan application serial no. 96121872, filed Jun. 15, 2007. All disclosure of the Taiwan application is incorporated herein by reference.

### BACKGROUND OF THE INVENTION

1. Field of the Invention

The present invention relates to a universal serial bus (USB) connector device, and more particularly, to a low profile universal serial bus connector device.

2. Description of Related Art

3C products in the current marketplace are designed with a trend toward small, thin and light-weighted. In particular, this trend is more apparent in portable personal devices with a USB interface, for example, USB flash drives. A low-profile design is thus desired. The thickness of conventional USB connectors has not been able to meet the low profile requirement. However, totally abandoning the conventional USB connectors will often result in an incompatibility between the connector of a host and the connector of the personal products. Under the precondition of reducing the thickness of the product and maintaining good electrical connection characteristics at the same time, a low profile USB connector has therefore been developed to substitute the conventional USB connector of the client product.

Existing low profile USB connectors typically employ the gold finger of a printed circuit board to replace the design of conventional USB connector which includes a mechanical housing associated therewith, and is thus exposed outside to reduce the overall thickness of the product using the USB connector. The existing low profile USB connector may overcome the large volume problem of the conventional USB connector. However, due to fatigue and lack of resiliency of resilient strips in some USB ports, when the existing low profile USB connector is inserted into such USB ports in which the resilient strips become fatigued and lack of resiliency, a poor contact may occur between the USB connector and the resilient strips, which may cause failure of the device equipped with such low profile USB connector.

### SUMMARY OF THE INVENTION

Accordingly, the present invention is directed to a connector module suitable for being used with a variety of universal serial bus ports.

The present invention is also directed to a universal serial bus connector device which is light-weighted and has a low profile.

The present invention is also directed to a method for fabricating a universal serial bus connector having a small volume, and may overcome the poor contact problem due to the lack of resiliency of the resilient strip in the USB port.

A connector module suitable for being used in a universal serial bus connector device is provided. The connector module includes a substrate with a conductive layer disposed thereon. The conductive layer includes a plurality of signal terminals. In addition, the connector module further includes a terminal element for jointing to the substrate. A conductive wire layer is disposed on the terminal element and may be coupled to the signal terminals.

According to one embodiment, a base material of the terminal element may be an insulating material, and the conductive wire layer may include a plurality of conductive wires and connecting terminals. As such, each of the conductive wires may be coupled to a corresponding one of the signal terminals via a corresponding one of the connecting terminals.

According to another embodiment, the terminal element may be a printed circuit board, and a plurality of through holes may be formed in the terminal element. As such, each of the conductive wires may be coupled to a corresponding one of the signal terminals via a corresponding one of the through holes.

According to another aspect of the present invention, a universal serial bus connector device includes a substrate and a terminal element. According to one embodiment of the present invention, the substrate includes a main portion and a connector portion. The main portion includes a control circuit, and the connector portion includes a plurality of signal terminals for coupling to the control circuit of the main portion. In addition, the terminal element may be jointed to the connector portion of the substrate, and includes a conductive wire layer for coupling to the signal terminals of the substrate.

According to one embodiment of the present invention, the connector device further includes an upper casing and a lower casing. The lower casing is used to support the substrate, and the upper casing can be jointed to the lower casing to enclose the substrate. In addition, the upper casing further has an opening allowing the conductive wire layer of the terminal element to be exposed.

According to yet another aspect of the present invention, a method for fabricating a universal serial bus connector device includes providing a main circuit on a substrate, forming a conductive layer on the substrate and coupling the conductive layer to the main circuit. The conductive layer includes a plurality of signal terminals. In addition, the method further includes mounting a terminal element to the conductive layer, forming a conductive wire layer on the terminal element and coupling the conductive wire layer to the signal terminals.

According to an embodiment of the present invention, a terminal element is further mounted on the substrate, and, therefore, the connector device may be suitable for being used with a variety of USB ports. In addition, the substrate may be a printed circuit board. Therefore, the thickness of the connector device of the present invention can be effectively reduced.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of a USB connector device according to an embodiment of the present invention.

FIG. 2A is a cross-sectional view of the connector device of FIG. 1.

FIG. 2B is a top view of the terminal element of FIG. 1.

FIG. 2C is a bottom view of the terminal element of FIG. 1.

FIG. 3 is a perspective view of a USB connector device according to another embodiment of the present invention.

FIG. 4A is a cross-sectional view of the connector device of FIG. 3.

FIG. 4B is a top view of the terminal element of FIG. 3.

FIG. 4C is a bottom view of the terminal element of FIG. 3.

FIG. 5 is a perspective view of the lower casing and the upper casing according to another embodiment of the present invention.

FIG. 6 is a flow chart of a method for fabricating a USB connector device according to an embodiment of the present invention.

### DESCRIPTION OF THE EMBODIMENTS

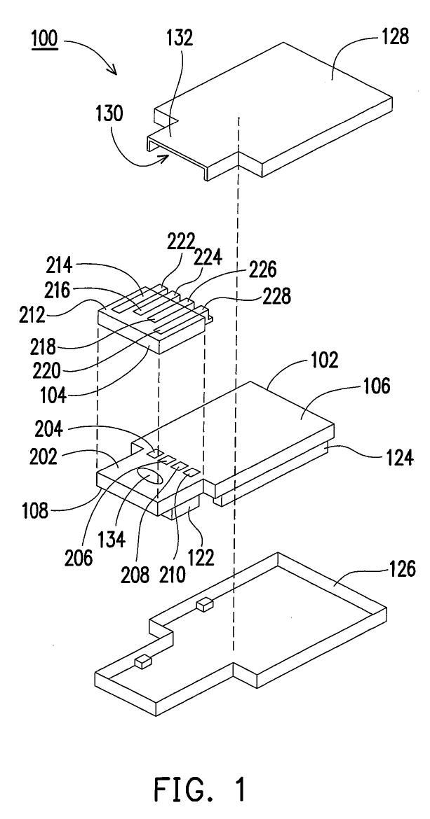

FIG. 1 is a perspective view of a USB connector device in accordance with an embodiment of the present invention. Referring to FIG. 1, the USB connector 100 includes a substrate 102 and a terminal element 104. The substrate 102 may be a printed circuit board. A plurality of circuit elements, 122 and 124 may be disposed on the substrate 102 to form a main circuit. The substrate 102 may be divided into a main portion 106 on which a most portion of the main circuit is formed, and a connector portion 108 which can be coupled to the terminal element 104 to form a connector module.

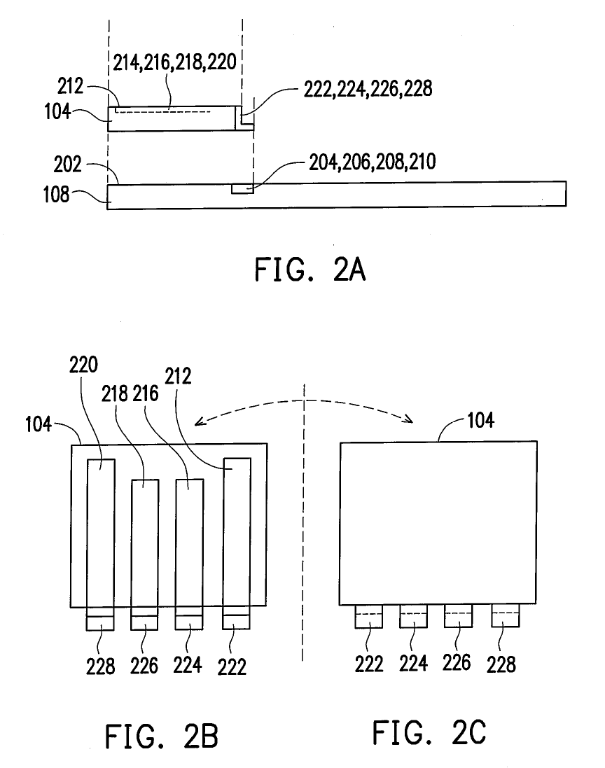

FIG. 2A is a cross-sectional view of the connector device 100 of FIG. 1, FIG. 2B is a top view of the terminal element 104 of FIG. 1, and FIG. 2C is a bottom view of the terminal element 104 of FIG. 1. Referring to FIGS. 1 and 2A-2C together, the connector portion 108 includes a conductive layer 202 formed thereon. The conductive layer 202 includes a plurality of signal terminals 204, 206, 208 and 210 which can be coupled to the main circuit of the substrate 102. In some embodiment, each of the signal terminals 204, 206, 208 and 210 has a metal pad connected by welding. In this embodiment, the signal terminals 204 and 210 are a power source terminal coupled to a working bias, and a ground terminal coupled to the ground, respectively. In addition, the signal terminals 206 and 208 may be a positive signal terminal to transmit a positive phase portion of a differential signal, and a negative signal terminal to transmit a negative phase portion of the differential signal, respectively.

The terminal element 104 may be mounted to the connector portion 108 by using a thermosetting adhesive 134. In this embodiment, a material of the terminal element 104 may be an insulating material, for example, plastic material. A conductive wire layer 212 of the terminal element 104 includes a plurality of conductive wires 214, 216, 218 and 220, and a plurality of connecting terminals 222, 224, 226 and 228. Therefore, each of the conductive wires 214, 216, 218 and 220 can be coupled to a corresponding one of the signal terminals 204, 206, 208 and 210 through a corresponding one of the connecting terminals 222, 224, 226 and 228.

It can be seen from the above description, by the coupling between the connecting terminals 222, 224, 226, 228 and the signal terminals 204, 206, 208, 210, the connector device 100 can output signals through the conductive wires 214, 216, 218 and 220. In addition, the terminal element 104 increases the height of the connector portion 108 of the substrate 102, and therefore, when the connector portion 108 of the connector device 100 is inserted into a USB port, the conductive wires 214, 216, 218 and 220 can effectively connect with resilient strips in the USB port. As such, even though the resilient strips may lack resiliency after long-time use, the USB signal can still be correctly transmitted through the connector portion 108 of the connector device 100 of the present invention.

In addition, the connector device 100 may further include a lower casing 126 and an upper casing 128. The lower casing 126 is used to support the substrate 102, and can be interconnected with the upper casing 128 to enclose the substrate 102. Besides, the upper casing 128 may further include a protruding portion 132 with an opening 130, and therefore the upper casing 128 not only can protect the terminal element 104, but also can allow the conductive wires 214, 216, 218 and 220 of the conductive wire layer 212 to be exposed from the opening 130.

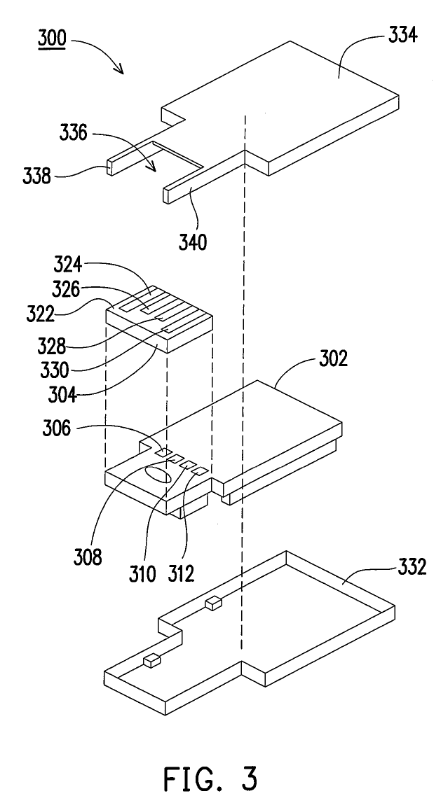

FIG. 3 is a perspective view of a USB connector device according to another embodiment of the present invention. Referring to FIG. 3, the connector device 300 of this embodiment likewise includes a substrate 302 and a terminal element 304. The substrate 302 has a structure generally similar to that of the substrate 102 of FIG. 1, and has signal terminals 306, 308, 310 and 312. In this embodiment, however, the terminal element 304 may also be another printed circuit board in order that structure of conductive wires 324, 326, 328 and 330 of a conductive wire layer 322 of the terminal element 304 can be designed flexibly. As such, the terminal element 304 may also have some circuit elements disposed thereon. It should be understood that, in this embodiment, the structure of the conductive wires 324, 326, 328 and 330 is not limited to elongated strip-shaped structure shown in FIG. 3, but can be another design according to the actual requirements.

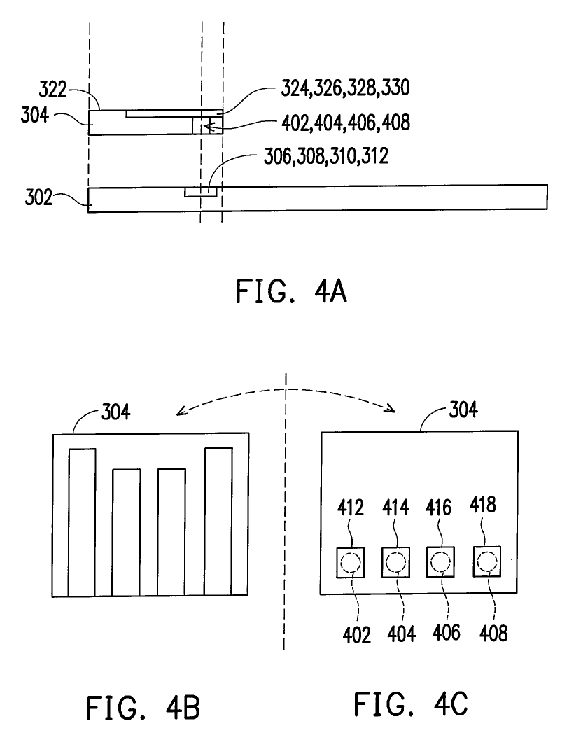

FIG. 4A is a cross-sectional view of the connector device 300 of FIG. 3. Referring to FIGS. 3 and 4A together, a plurality of through holes 402, 404, 406 and 408, in positions corresponding to the signal terminals 306, 308, 310 and 312 of the substrate 302, respectively, may be formed in the terminal element 304. As such, the conductive wires 324, 326, 328 and 330 can be passed through the through holes 402, 404, 406 and 408, respectively and coupled to the signal terminals 306, 308, 310 and 312 by welding.

FIG. 4B is a top view of the terminal element 304 of FIG. 3, and FIG. 4C is a bottom view of the terminal element 304 of FIG. 3. Referring to FIGS. 4B and 4C together, inside of the through holes 402, 404, 406 and 408 may be coated with a conductive material, for example, copper foil. In addition, metal pads 412, 414, 416 and 418 may be formed on an underside of the terminal element 304 at the through holes 402, 404, 406 and 408, respectively. As such, each of the conductive wires 324, 326, 328 and 330 can be coupled to the signal terminals 306, 308, 310 and 312 through the metal pads 412, 414, 416 and 418, respectively.

Referring again to FIG. 3, the connector device 300 likewise includes a lower casing 332 and an upper casing 334. The function of the lower casing 332 and the upper casing 334 is the same as that of the lower casing 126 and the upper casing 128 of FIG. 1, and thus is not repeated herein. The upper casing 334 likewise has an opening 336 for exposing the conductive wire layer 322 of the terminal element 304. Differently, rib structures 338 and 340 may be formed on two sides of the opening 336, for protecting the terminal element 304. In some other possible embodiments, the lower casing 332 and the upper casing 334 can be used with the connector device 100 of FIG. 1.

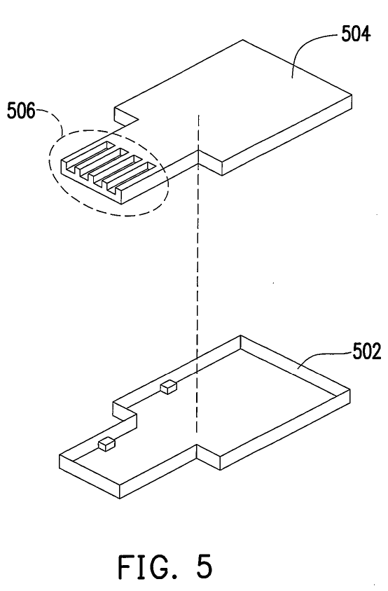

FIG. 5 is a perspective view of the lower casing and the upper casing in accordance with another embodiment of the present invention. Referring to FIG. 5, in some other embodiments, the connector device 300 of FIG. 3 may also use the lower casing 502 and the upper casing 504 of FIG. 5. Similarly, the upper casing 504 has a patterned opening 506, a shape of which is configured to fit with the structure of the conductive wires 324, 326, 328 and 330 of the terminal element 304 of FIG. 3. As such, when the substrate 302 is enclosed by the lower casing 502 and the upper casing 504, the conductive wires 324, 326, 328 and 330 of the terminal element 304 can still be exposed from the patterned opening 506 of the upper casing 504.

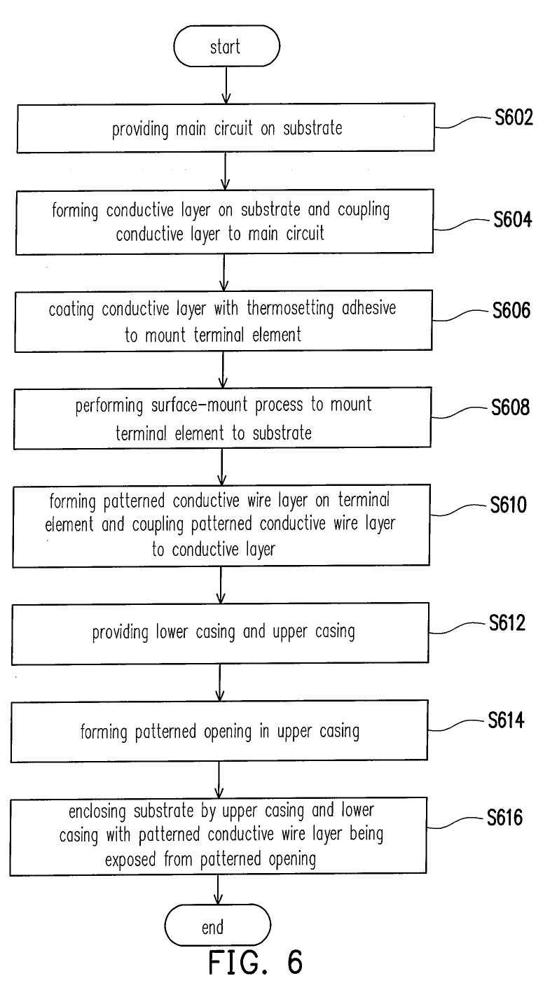

FIG. 6 is a flow chart of a method for fabricating a USB connector device according to an embodiment of the present invention. The flow chart shown in FIG. 6 is based on the embodiments described above. Referring to FIG. 6, a main circuit is first provided on a substrate (S602). In addition, a conductive layer may be formed on the substrate (S604). The conductive layer may include a plurality of signal terminals, as shown in FIG. 1, which are coupled to the main circuit. In some embodiments, each signal terminal may include a metal pad connected by welding.

Besides, in some embodiments, the connector portion 108 may be coated with a thermosetting adhesive to mount the terminal element on the substrate (S606). Next, a surface-mount process may be performed to mount a terminal element to the substrate (S608). It should be understood that the terminal element can be mounted to the substrate using various technologies without departing from the scope or spirit of the invention.

Referring to FIG. 6, a conductive wire layer may further be formed on the terminal element (S610). In this embodiment, the conductive wire layer may include a plurality of conductive wires coupled to the signal terminals of the conductive layer, respectively. As such, the USB connector device can transmit the signals output from the signal terminals through the conductive wires of the conductive wire layer.

In some possible embodiments, the method of the present invention may further include providing a lower casing and an upper casing (S612). In addition, an opening may be defined in the upper casing (S614). As such, the substrate may be enclosed by interconnecting the lower casing and the upper casing, with the patterned conductive wires of the terminal element being exposed from the patterned opening of the upper casing (S616). In some embodiments, interconnection between the lower casing and the upper casing can be achieved by performing, for example but not limited to, an ultrasonic bonding process.

In summary, a main body portion of the connector device of the present invention comprises only a substrate, for example, a printed circuit board, and therefore, the connector device of the present invention can be made light and thin. In addition, the present invention further employs a terminal element mounted on a connector portion of the substrate to effectively increase the height of the connector portion, and, therefore, the connector device of the present invention may be suitable for being used with a variety of USB ports, and may overcome the poor contact problem due to the lack of resiliency of the resilient strip in the USB port.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A connector module is configured to be used in a universal serial bus connector device, comprising:
a substrate;
a conductive layer, disposed on the substrate, comprising a plurality of signal terminals;
a terminal element, configured to be jointed to the substrate; and
a conductive wire layer, disposed on the terminal element, configured to be coupled to a corresponding one of the signal terminals.

2. The connector module according to claim 1, wherein the substrate includes a printed circuit board.

3. The connector module according to claim 1, wherein the signal terminals include:
a power source terminal, configured to be coupled to a working bias;
a positive signal terminal, configured to transmit a positive phase portion of a differential signal;
a negative signal terminal, configured to transmit a negative phase portion of the differential signal; and
a grounding terminal, configured to be grounded.

4. The connector module according to claim 1, wherein a base material of the terminal element includes an insulating material.

5. The connector module according to claim 1, wherein the terminal element includes a printed circuit board.

6. The connector module according to claim 1, wherein the conductive wire layer includes a plurality of conductive wires.

7. The connector module according to claim 6, wherein the conductive wire layer includes a plurality of connecting terminals coupled to the conductive wires, respectively, such that each of the conductive wires is coupled to a corresponding one of the signal terminals via one of the connecting terminals.

8. The connector module according to claim 6, wherein the terminal element comprises a plurality of through holes such that each of the conductive wires is coupled to a corresponding one of the signal terminals via one of the through holes.

9. A universal serial bus connector device, comprising:
a substrate, including a main portion with a control circuit disposed thereon, and a connector portion having a plurality of signal terminals coupled to the control circuit; and
a terminal element, configured to be jointed to the connector portion of the substrate, including a conductive wire layer configured to be coupled to the signal terminals.

10. The universal serial bus connector device according to claim 9, wherein the signal terminals includes:
a power source terminal, configured to be coupled to a working bias;
a positive signal terminal, configured to transmit a positive phase portion of a differential signal;
a negative signal terminal, configured to transmit a negative phase portion of the differential signal; and
a grounding terminal, configured to be grounded.

11. The universal serial bus connector device according to claim 9, wherein a base material of the terminal element comprises an insulating material.

12. The universal serial bus connector device according to claim 9, wherein the terminal element includes a printed circuit board.

13. The universal serial bus connector device according to claim 9, wherein the conductive wire layer includes a plurality of conductive wires.

14. The universal serial bus connector device according to claim 13, wherein the conductive wire layer includes a plurality of connecting terminals coupled to the conductive wires, respectively, such that each of the conductive wires is coupled to a corresponding one of the signal terminals via one of the connecting terminals.

15. The universal serial bus connector device according to claim 13, wherein the terminal element has a plurality of through holes such that each of the conductive wires is coupled to a corresponding one of the signal terminals via one of the through holes.

16. The universal serial bus connector device according to claim 9, further comprising:
a lower casing, configured to support the substrate; and
an upper casing, configured to be jointed to the lower casing to enclose the substrate.

17. The universal serial bus connector device according to claim 16, wherein the upper casing includes a protruding portion and comprises an opening allowing the conductive wire layer to be exposed.

18. The universal serial bus connector device according to claim 16, wherein the upper casing includes two rib structures each disposed on one of two sides of an end of the upper casing, and the upper casing comprises an opening allowing the conductive wire layer to be exposed.

19. The universal serial bus connector device according to claim 16, wherein the upper casing has a patterned opening allowing the conductive wire layer to be exposed.

20. The universal serial bus connector device according to claim 9, wherein the substrate includes a printed circuit board.

21. A method for fabricating a universal serial bus connector device, comprising:
providing a main circuit on a substrate including a connector portion;
forming a conductive layer on the connector portion of the substrate and coupling the conductive layer to the main circuit, wherein the conductive layer includes a plurality of signal terminals;
mounting a terminal element on the conductive layer; and
forming a conductive wire layer on the terminal element and coupling the conductive wire layer to the signal terminals.

22. The method for fabricating a universal serial bus connector device according to claim 21, wherein the conductive wire layer includes a plurality of conductive wires.

23. The method for fabricating a universal serial bus connector device according to claim 21, wherein a process of coupling the conductive wire layer to the signal terminals includes:
coating the connector portion with a thermosetting adhesive to mount the terminal element on the connector portion; and
coupling each of the conductive wires to one of the signal terminals by welding.

24. The method for fabricating a universal serial bus connector device according to claim 21, wherein the process of coupling the conductive wire layer to the signal terminals includes:
forming a plurality of through holes in the terminal element;
coating the connector portion with a thermosetting adhesive to mount the terminal element on the connector portion; and
coupling each of the conductive wires to a corresponding one of the signal terminals through one of the through holes.

25. The method for fabricating a universal serial bus connector device according to claim 21, further comprising:
providing an upper casing and a lower casing;
forming an opening in the upper casing; and
enclosing the substrate by the upper casing and the lower casing with the conductive wire layer being exposed from the opening.

26. The method for fabricating a universal serial bus connector device according to claim 25, wherein the upper casing and the lower casing are interconnected by ultrasonic bonding.

27. The method for fabricating a universal serial bus connector device according to claim 21, wherein the substrate includes a printed circuit board.

28. The method for fabricating a universal serial bus connector device according to claim 21, wherein a base material of the terminal element is one of an insulating material and a printed circuit board.
